(19) United States
(12) Patent Application Publication
(10) Pub. No.: US 2026/0150883 A1
(43) Pub. Date: Jun. 4, 2026

(54) AN AEROSOL-GENERATING ARTICLE COMPRISING A CAPSULE AND SUSCEPTOR

(71) Applicant: Philip Morris Products S.A., Neuchatel (CH)

(72) Inventor: Jerome UTHURRY, Neuchâtel (CH)

(73) Assignee: Philip Morris Products S.A., Neuchatel (CH)

(21) Appl. No.: 19/122,400

(22) PCT Filed: Oct. 27, 2023
(86) PCT No.: PCT/EP2023/080146

§ 371 Date: Apr. 18, 2025

(30) Foreign Application Priority Data
Oct. 27, 2022 (EP) 22204200

(51) Int. Cl. A24D 1/20; A24C 5/01; A24D 1/00; A24F 40/20; A24F 40/465; H05B 6/02

(52) U.S. Cl. CPC A24D 1/20; A24C 5/01; A24D 1/002; A24F 40/20; A24F 40/465; H05B 6/02

(57) ABSTRACT

An aerosol-generating article for generating an inhalable aerosol is provided, including a capsule including: a capsule outer wall defining an internal cavity; first particles and second particles within the internal cavity, the first particles including an aerosol-forming substrate; the second particles including a susceptor material and no aerosol-forming substrate; at least one of the following: the first and the second particles having first and second cross-sectional dimensions being a diameter of the particles and being the same, respectively, the first and the second particles having a spherical shape, having a first and a second mass, and having a first and a second density being the same, respectively, a ratio of a total number of first particles to second particles being between 0.2 to 1 and 5 to 1, or a ratio of a total mass of first particles to second particles being between 0.2 to 1 and 5 to 1.

The present invention relates to an aerosol-generating article comprising a capsule, the capsule comprising plurality of first particles of aerosol-forming substrate and a susceptor. The present invention also relates to an aerosol-generating system comprising the aerosol-generating article, and methods of forming the capsule.

Aerosol-generating articles in which an aerosol-forming substrate, such as a tobacco-containing substrate, is heated rather than combusted, are known in the art. Typically, in such heated smoking articles an aerosol is generated by the transfer of heat from a heat source to a physically separate aerosol-forming substrate or material, which may be located in contact with, within, around, or downstream of the heat source. During use of the aerosol-generating article, volatile compounds are released from the aerosol-forming substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-forming substrate of a heated aerosol-generating article. For example, electrically heated aerosol-generating devices have been proposed that comprise a resistive heating element, wherein the resistive heating element generates heat for heating the aerosol-forming substrate. Other electrically heated aerosol-generating device have been proposed that comprise an induction heating system, wherein an inductor coil generates a varying magnetic field for heating a susceptor element, the susceptor element arranged to heat the aerosol-forming substrate. For example, inductively heatable aerosol-generating articles comprising an aerosol-forming substrate and a susceptor arranged within the aerosol-forming substrate have been proposed in WO 2015/176898 A1.

Certain types of aerosol-forming substrates containing nicotine and a relatively high aerosol former content are known, for example, nicotine containing gels and films. Such substrates are typically very stable during storage and advantageously provide a very consistent delivery of nicotine to the consumer upon heating. They can also advantageously generate aerosol at a lower temperature than other solid substrates. However, the use of aerosol-forming substrates of this type can also present issues. The relatively high aerosol former content increases the risk of leakage of aerosol former from the substrate during storage as well as during use. In addition, certain substrates such as gel compositions will commonly melt upon heating of the aerosol-forming substrate within an aerosol-generating device during use. The viscosity of the gel composition therefore increases significantly and it can become more difficult to control the movement of the gel composition and in particular, to retain it within the aerosol-generating article. The leakage of aerosol former or melted gel composition from the aerosol-generating article is undesirable, since it can leak into the heating chamber of the aerosol-generating device and potentially contaminate the aerosol-generating device. The leakage of aerosol former or gel composition may also be potentially unpleasant for the consumer.

Furthermore, even solid aerosol-forming substrates may comprise one or more volatile compounds, such as one or more aerosol formers, that may escape from an aerosol-generating article over time if the aerosol-generating article is stored incorrectly.

It would therefore be desirable to provide a novel aerosol-generating article having an arrangement that provides improved retention of the aerosol-forming substrate and volatile compounds within the aerosol-generating article during storage and use. It would be further desirable to provide such an aerosol-generating article that enables the aerosol-forming substrate to be efficiently heated so that aerosol can be generated from the aerosol-forming substrate in an efficient and consistent way.

The present disclosure relates to an aerosol-generating article for generating an inhalable aerosol upon heating. The aerosol-generating article may comprise a capsule. The capsule may comprise a capsule outer wall defining an internal cavity. The capsule may comprise a plurality of first particles within the internal cavity. Each of the first particles may comprise an aerosol-forming substrate. The capsule may further comprise a single susceptor element within the internal cavity. The capsule may further comprise a plurality of second particles within the internal cavity. Each of the second particles may comprise a susceptor material and no aerosol-forming substrate.

According to the present invention, there is provided an aerosol-generating article for generating an inhalable aerosol upon heating, the aerosol-generating article comprising a capsule. The capsule comprises a capsule outer wall defining an internal cavity and a plurality of first particles within the internal cavity. Each of the first particles comprises an aerosol-forming substrate. The capsule further comprises only one of the following: a plurality of second particles within the internal cavity, each of the second particles comprising a susceptor material and no aerosol-forming substrate; or a single susceptor element within the internal cavity.

The term “aerosol-generating article” is used herein to denote an article comprising an aerosol-forming substrate which is heated to produce and deliver an inhalable aerosol to a consumer. As used herein, the term “aerosol-forming substrate” denotes a substrate capable of releasing volatile compounds upon heating to generate an aerosol.

As used herein, the term “aerosol-generating device” refers to a device comprising a heater element that interacts with the aerosol-forming substrate of the aerosol-generating article to generate an aerosol.

As used herein, the term “longitudinal” refers to the direction corresponding to the main longitudinal axis of the aerosol-generating article, which extends between the upstream and downstream ends of the aerosol-generating article. As used herein, the terms “upstream” and “downstream” describe the relative positions of elements, or portions of elements, of the aerosol-generating article in relation to the direction in which the aerosol is transported through the aerosol-generating article during use.

During use, air is drawn through the aerosol-generating article in the longitudinal direction. The term “transverse” refers to the direction that is perpendicular to the longitudinal axis.

The term “length” denotes the dimension of a component of the aerosol-generating article in the longitudinal direction. For example, it may be used to denote the dimension of the hollow tubular element or capsule in the longitudinal direction.

As used herein, the term “solid” refers to an aerosol-forming substrate that is not a liquid or a gas and which does not flow such that it retains its shape and form at room temperature. In the context of the present invention, the term “solid” encompasses gel materials and compositions.

As used herein, the terms “susceptor”, “susceptor element” and “susceptor material” refer to materials that are capable of being inductively heated. That is, a susceptor material is capable of absorbing electromagnetic energy and converting it to heat.

Advantageously, providing particles of susceptor material or a single susceptor element in the capsule internal cavity provides direct contact between the susceptor and the particles of aerosol-forming substrate. Advantageously, direct contact between the susceptor and the aerosol-forming substrate provides efficient heating of the aerosol-forming substrate. Advantageously, direct contact between the susceptor and the aerosol-forming substrate facilitates rapid heating of the aerosol-forming substrate at the start of a heating cycle. Advantageously, rapid heating of the aerosol-forming substrate facilitates rapid aerosol delivery to a user.

Advantageously, providing the aerosol-forming substrate in a plurality of first particles distinct from a plurality of second particles of susceptor material, or a single susceptor element, may simplify the manufacture of the aerosol-generating article. For example, it may be easier manufacture the first particles of aerosol-forming substrate separately from the single susceptor element or the plurality of second particles of susceptor material.

Advantageously, positioning the first particles of aerosol-forming substrate in the internal cavity of the capsule with the single susceptor element or the plurality of second particles of susceptor material may facilitate even distribution of the aerosol-forming substrate with respect to the susceptor. Advantageously, even distribution of the aerosol-forming substrate with respect to the susceptor may facilitate even heating of the aerosol-forming substrate and therefore uniform aerosol delivery throughout a heating cycle. Advantageously, even distribution of the aerosol-forming substrate with respect to the susceptor may facilitate even heating of the aerosol-forming substrate such that an aerosol generation profile of the aerosol-generating article is independent of orientation of the capsule in the aerosol-generating article and independent of orientation of aerosol-generating article in an aerosol-generating device.

Advantageously, providing a susceptor as part of the aerosol-generating article allows replacement of the heater each time the aerosol-generating article is replaced. Advantageously, this eliminates the issue of heater contamination that is inherent with aerosol-generating device comprising a resistive heater that is repeatedly used to heat multiple aerosol-generating articles.

The capsule may comprise the plurality of second particles. Preferably, the plurality of second particles is mixed with the plurality of first particles. Advantageously, mixing the second particles with the first particles may facilitate an even distribution of the aerosol-forming substrate with respect to the susceptor material. Advantageously, this may facilitate an efficient transfer of heat from the susceptor material to the aerosol-forming substrate.

The plurality of first particles may have any suitable form. The plurality of first particles may comprise a plurality of beads, pellets, granules, strips, shreds or flakes.

The plurality of second particles may have any suitable form. The plurality of second particles may comprise a plurality of beads, pellets, granules, strips, shreds or flakes.

Each of the first particles may have an outer surface comprising a first shape. Each of the second particles may have an outer surface comprising a second shape.

The first shape and the second shape may be the same.

The second shape may be different to the first shape. Part of the second shape may be configured to engage with part of the first shape. In other words, part of the second shape may be complementary to part of the first shape. Part of the second shape may be configured to receive part of the first shape. Part of the second shape may be configured to be received in part of the first shape. In other words, part of the first shape may be configured to received part of the second shape.

Advantageously, providing first and second shapes configured to engage with each other may increase or maximise contact between the first particles and the second particles. Advantageously, increasing or maximising contact between the first particles and the second particles may facilitate an efficient transfer of heat from the susceptor material to the aerosol-forming substrate.

Preferably, the first shape is configured to reduce or prevent engagement between first particles. In other words, preferably, the first shape is configured so that it cannot engage with or receive part of itself. Advantageously, this may facilitate mixing of the first particles with the second particles.

Preferably, the second shape is configured to reduce or prevent engagement between second particles. In other words, preferably, the second shape is configured so that it cannot engage with or receive part of itself. Advantageously, this may facilitate mixing of the first particles with the second particles.

Preferably, each of the second particles has at least one of a size and a shape to reduce or minimise interlocking of the second particles with each other. Advantageously, reducing or minimising interlocking of the second particles with each other may facilitate mixing of the second particles with the first particles.

Preferably, each of the second particles has at least one of a size and a shape to increase or maximise contact between the second particles and the first particles. Advantageously, increasing or maximising contact between the second particles and the first particles may facilitate the transfer of heat from the susceptor material to the aerosol-forming substrate.

The first shape may be a convex shape. The first shape may be a sphere, an ellipsoid, or an ovoid. The first shape may be a polyhedral shape. The first shape may be a stellated polyhedral shape.

The second shape may be a convex shape. The second shape may be a sphere, an ellipsoid, or an ovoid. The second shape may be a polyhedral shape. The second shape may be a stellated polyhedral shape.

Each of the first shape and second shape may be a sphere, an ellipsoid or an ovoid. Advantageously, providing each of the first particles and the second particles with a spherical shape, an ellipsoidal shape or an ovoidal shape may simplify the manufacture of the first particles and the second particles. Advantageously, providing each of the first particles and the second particles with a spherical shape, an ellipsoidal shape or an ovoidal shape may facilitate mixing of the second particles with the first particles.

The first shape may be a sphere, an ellipsoid or an ovoid, and the second shape may be a stellated polyhedral shape. Advantageously, providing each of the first particles with a spherical shape, an ellipsoidal shape or an ovoidal shape and each of the second particles with a stellated polyhedral shape may increase or maximise contact between the first particles and the second particles.

Each of the first particles may have a first size and each of the second particles may have a second size.

The first size may be different to the second size.

The first size may be the same as the second size.

Advantageously, providing the same first and second sizes may facilitate homogenous distribution of the plurality first particles within the plurality of second particles. Advantageously, homogenous distribution of the plurality first particles within the plurality of second particles may facilitate an efficient transfer of heat from the susceptor material to the aerosol-forming substrate.

Each of the first particles may have a first cross-sectional dimension. To accommodate variations in sizes of the first particles, either intentional or due to manufacturing tolerances, the first cross-sectional dimension is a number average cross-sectional dimension.

Each of the second particles may have a second cross-sectional dimension. To accommodate variations in sizes of the second particles, either intentional or due to manufacturing tolerances, the second cross-sectional dimension is a number average cross-sectional dimension.

Preferably, the first and second cross-sectional dimensions are the maximum cross-sectional dimensions of the first and second particles respectively. For particles having a spherical shape, the maximum cross-sectional dimension is the diameter of the sphere. For particles having an ellipsoidal or ovoid shape, the maximum cross-sectional dimension is the major axis of the ellipsoidal or ovoid shape.

The first cross-sectional dimension may be different to the second cross-sectional dimension.

The first cross-sectional dimension may be the same as the second cross-sectional dimension. Advantageously, providing the same first and second cross-sectional dimensions may facilitate homogenous distribution of the plurality first particles within the plurality of second particles. Advantageously, homogenous distribution of the plurality first particles within the plurality of second particles may facilitate an efficient transfer of heat from the susceptor material to the aerosol-forming substrate.

The maximum first cross-sectional dimension of the first particles is preferably at least 0.05 millimetres, more preferably at least 0.1 millimetres, more preferably at least 0.15 millimetres, more preferably at least 0.2 millimetres, more preferably at least 0.25 millimetres, more preferably at least 0.5 millimetres, more preferably at least 0.75 millimetres, more preferably at least 1 millimetre. Preferably, the maximum first cross-sectional dimension of the first particles is no more than 10 millimetres, more preferably no more than 9 millimetres, more preferably no more than 8 millimetres, more preferably no more than 6 millimetres, more preferably no more than 5 millimetres. Providing relatively large first particles within these ranges may be preferable when the capsule outer wall is provided with holes to form air inlets and outlets, as described below. The relatively large maximum dimension of the first particles may ensure that the first particles are not lost through the holes in the capsule outer wall.

The maximum second cross-sectional dimension of the second particles is preferably at least 0.05 millimetres, more preferably at least 0.1 millimetres, more preferably at least 0.15 millimetres, more preferably at least 0.2 millimetres, more preferably at least 0.25 millimetres, more preferably at least 0.5 millimetres, more preferably at least 0.75 millimetres, more preferably at least 1 millimetre. Preferably, the maximum second cross-sectional dimension of the second particles is no more than 10 millimetres, more preferably no more than 9 millimetres, more preferably no more than 8 millimetres, more preferably no more than 6 millimetres, more preferably no more than 5 millimetres. Providing relatively large second particles within these ranges may be preferable when the capsule outer wall is provided with holes to form air inlets and outlets, as described below. The relatively large maximum dimension of the second particles may ensure that the second particles are not lost through the holes in the capsule outer wall.

Each of the first particles may have a first mass. To accommodate variations in mass of the first particles, either intentional or due to manufacturing tolerances, the first mass is a number average mass.

Each of the second particles may have a second mass. To accommodate variations in mass of the second particles, either intentional or due to manufacturing tolerances, the second mass is a number average mass.

The first mass may be different to the second mass.

Preferably, a difference between the first mass and the second mass is less than 10 percent of the first mass. Most preferably, the first mass may be the same as the second mass. Advantageously, providing the same first and second masses may facilitate homogenous distribution of the plurality first particles within the plurality of second particles. Advantageously, homogenous distribution of the plurality first particles within the plurality of second particles may facilitate an efficient transfer of heat from the susceptor material to the aerosol-forming substrate.

The first mass is preferably at least 0.05 micrograms, more preferably at least 0.1 micrograms, more preferably at least 0.2 micrograms, more preferably at least 0.3 micrograms, more preferably at least 0.4 micrograms, more preferably at least 0.5 micrograms, more preferably at least 0.6 micrograms, more preferably at least 0.7 micrograms, more preferably at least 0.8 micrograms, more preferably at least 0.9 micrograms, more preferably at least 1 microgram, more preferably at least 10 micrograms, more preferably at least 100 micrograms, more preferably at least 200 micrograms, more preferably at least 500 micrograms, more preferably at least 1 milligram. The first mass is preferably no more than 600 milligrams, more preferably no more than 500 milligrams, more preferably no more than 400 milligrams, more preferably no more than 300 milligrams, more preferably no more than 200 milligrams, more preferably no more than 100 milligrams, more preferably no more than 50 milligrams, more preferably no more than 10 milligrams.

The second mass is preferably at least 0.05 micrograms, more preferably at least 0.1 micrograms, more preferably at least 0.2 micrograms, more preferably at least 0.3 micrograms, more preferably at least 0.4 micrograms, more preferably at least 0.5 micrograms, more preferably at least 0.6 micrograms, more preferably at least 0.7 micrograms, more preferably at least 0.8 micrograms, more preferably at least 0.9 micrograms, more preferably at least 1 microgram, more preferably at least 10 micrograms, more preferably at least 100 micrograms, more preferably at least 200 micrograms, more preferably at least 500 micrograms, more preferably at least 1 milligram. The second mass is preferably no more than 600 milligrams, more preferably no more than 500 milligrams, more preferably no more than 400 milligrams, more preferably no more than 300 milligrams, more preferably no more than 200 milligrams, more preferably no more than 100 milligrams, more preferably no more than 50 milligrams, more preferably no more than 10 milligrams.

Each of the first particles may have a first density. To accommodate variations in density of the first particles, either intentional or due to manufacturing tolerances, the first density is a number average density.

Each of the second particles may have a second density. To accommodate variations in density of the second particles, either intentional or due to manufacturing tolerances, the second density is a number average density.

The first density may be different to the second density.

Preferably, a difference between the first density and the second density is less than 10 percent of the first density. Most preferably, the first density may be the same as the second density. Advantageously, providing the same first and second densities may facilitate homogenous distribution of the plurality first particles within the plurality of second particles. Advantageously, homogenous distribution of the plurality first particles within the plurality of second particles may facilitate an efficient transfer of heat from the susceptor material to the aerosol-forming substrate.

The first density is preferably at least 0.1 milligrams per cubic millimetre, more preferably at least 0.2 milligrams per cubic millimetre, more preferably at least 0.25 milligrams per cubic millimetre, more preferably at least 0.3 milligrams per cubic millimetre, more preferably at least 0.35 milligrams per cubic millimetre, more preferably at least 0.4 milligrams per cubic millimetre, more preferably at least 0.45 milligrams per cubic millimetre, more preferably at least 0.5 milligrams per cubic millimetre, more preferably at least 0.55 milligrams per cubic millimetre, more preferably at least 0.6 milligrams per cubic millimetre, more preferably at least 0.65 milligrams per cubic millimetre, more preferably at least 0.7 milligrams per cubic millimetre, more preferably at least 0.75 milligrams per cubic millimetre, more preferably at least 0.8 milligrams per cubic millimetre. The first density is preferably no more than 2 milligrams per cubic millimetre, more preferably no more than 1.95 milligrams per cubic millimetre, more preferably no more than 1.9 milligrams per cubic millimetre, more preferably no more than 1.85 milligrams per cubic millimetre, more preferably no more than 1.8 milligrams per cubic millimetre, more preferably no more than 1.75 milligrams per cubic millimetre, more preferably no more than 1.7 milligrams per cubic millimetre, more preferably no more than 1.65 milligrams per cubic millimetre, more preferably no more than 1.6 milligrams per cubic millimetre, more preferably no more than 1.55 milligrams per cubic millimetre, more preferably no more than 1.5 milligrams per cubic millimetre, more preferably no more than 1.45 milligrams per cubic millimetre, more preferably no more than 1.4 milligrams per cubic millimetre, more preferably no more than 1.35 milligrams per cubic millimetre, more preferably no more than 1.3 milligrams per cubic millimetre, more preferably no more than 1.25 milligrams per cubic millimetre, more preferably no more than 1.2 milligrams per cubic millimetre.

The second density is preferably at least 0.1 milligrams per cubic millimetre, more preferably at least 0.2 milligrams per cubic millimetre, more preferably at least 0.25 milligrams per cubic millimetre, more preferably at least 0.3 milligrams per cubic millimetre, more preferably at least 0.35 milligrams per cubic millimetre, more preferably at least 0.4 milligrams per cubic millimetre, more preferably at least 0.45 milligrams per cubic millimetre, more preferably at least 0.5 milligrams per cubic millimetre, more preferably at least 0.55 milligrams per cubic millimetre, more preferably at least 0.6 milligrams per cubic millimetre, more preferably at least 0.65 milligrams per cubic millimetre, more preferably at least 0.7 milligrams per cubic millimetre, more preferably at least 0.75 milligrams per cubic millimetre, more preferably at least 0.8 milligrams per cubic millimetre. The second density is preferably no more than 2 milligrams per cubic millimetre, more preferably no more than 1.95 milligrams per cubic millimetre, more preferably no more than 1.9 milligrams per cubic millimetre, more preferably no more than 1.85 milligrams per cubic millimetre, more preferably no more than 1.8 milligrams per cubic millimetre, more preferably no more than 1.75 milligrams per cubic millimetre, more preferably no more than 1.7 milligrams per cubic millimetre, more preferably no more than 1.65 milligrams per cubic millimetre, more preferably no more than 1.6 milligrams per cubic millimetre, more preferably no more than 1.55 milligrams per cubic millimetre, more preferably no more than 1.5 milligrams per cubic millimetre, more preferably no more than 1.45 milligrams per cubic millimetre, more preferably no more than 1.4 milligrams per cubic millimetre, more preferably no more than 1.35 milligrams per cubic millimetre, more preferably no more than 1.3 milligrams per cubic millimetre, more preferably no more than 1.25 milligrams per cubic millimetre, more preferably no more than 1.2 milligrams per cubic millimetre.

Preferably, a ratio of the total number of first particles to the total number of second particles in the internal cavity is between 0.2 to 1 and 5 to 1, more preferably between 0.3 to 1 and 4 to 1, more preferably between 0.4 to 1 and 3.5 to 1, more preferably between 0.5 to 1 and 3 to 1, more preferably between 0.6 to 1 and 2.5 to 1, more preferably between 0.7 to 1 and 2 to 1, more preferably between 0.8 to 1 and 1.5 to 1, more preferably between 0.9 to 1 and 1.1 to 1, most preferably about 1 to 1. Advantageously, providing a ratio of the total number of first particles to the total number of second particles within these ranges may facilitate efficient and even heating of the aerosol-forming substrate by the susceptor material.

Preferably, a ratio of the total mass of first particles to the total mass of second particles in the internal cavity is between 0.2 to 1 and 5 to 1, more preferably between 0.3 to 1 and 4 to 1, more preferably between 0.4 to 1 and 3.5 to 1, more preferably between 0.5 to 1 and 3 to 1, more preferably between 0.6 to 1 and 2.5 to 1, more preferably between 0.7 to 1 and 2 to 1, more preferably between 0.8 to 1 and 1.5 to 1, more preferably between 0.9 to 1 and 1.1 to 1, most preferably about 1 to 1. Advantageously, providing a ratio of the total mass of first particles to the total mass of second particles within these ranges may facilitate efficient and even heating of the aerosol-forming substrate by the susceptor material.

Each of the second particles may have a homogenous structure. Advantageously, a homogenous structure may simplify the manufacture of the second particles. Each of the second particles may comprise a solid particle of susceptor material. Each of the second particles may have a uniform density.

Each of the second particles may have a heterogenous structure. Advantageously, a heterogenous structure may facilitate providing each second particle with at least one of a desired, size, mass, and density. Each of the second particles may have a non-uniform density.

Each of the second particles may comprise a shell of susceptor material and a void defined by the shell of susceptor material. The void may be at least partially filled with a non-susceptor material. The shell of susceptor material may have a first density and the non-susceptor material may have a second density, wherein the second density is less than the first density. The non-susceptor material may comprise a non-conductive foam. The void may be free of solid or liquid materials. The void may be filled with a gas. The gas may comprise air. The gas may comprise an inert gas. The void may comprise a partial vacuum or a vacuum.

Each of the second particles may comprise a plurality of layers of susceptor material. The plurality of layers of susceptor material may comprise a first layer comprising a first susceptor material and a second layer comprising a second susceptor material, wherein the first susceptor material is different to the second susceptor material. The first susceptor material may have a first density and the second susceptor material may have a second density, wherein the first density is different to the second density.

Each of the second particles may have at least one of a size and a shape to increase a surface area of the second particle. Advantageously, increasing the surface area of each second particle may facilitate the transfer of heat from the susceptor material to the aerosol-forming substrate.

Each of the second particles may comprise a plurality of fins. Preferably, each fin is formed from the susceptor material. Each of the second particles may comprise a plurality of discs or plates of susceptor material, wherein each disc or plate forms one of the plurality of fins. The following optional or preferred features for embodiments in which each of the second particles comprises a plurality discs may be applied equally to embodiments in which each of the second particles comprises a plurality of plates. Preferably, the discs are arranged in a stack. Preferably, the discs are spaced apart from each other. Preferably, the discs are connected to each other by a central column. Preferably, the central column is formed from the susceptor material.

The capsule may comprise the single susceptor element, wherein the single susceptor element comprises a susceptor material. As used herein, the term “single susceptor element” refers to a susceptor element that is the only susceptor element within the capsule.

The first particles may comprise any of the optional or preferred features as described above.

The single susceptor element may have any suitable size or shape. The single susceptor element may have a convex shape. The single susceptor element may have a planar shape. The single susceptor element may have an elongate shape. The single susceptor element may have a shape selected from a rod, a pin, a cylinder, a sphere, an ellipsoid, an ovoid, a sheet, a disc, a cone, and a truncated cone.

The further optional and preferred features described below are applicable to embodiments in which the capsule comprises a plurality of second particles and embodiments in which the capsule comprises a single susceptor element.

Preferably, the susceptor material comprises at least one metal. The susceptor material may comprise at least one metal alloy. The susceptor material may comprise a foam.

Preferably, the susceptor material comprises a ferromagnetic metallic material. The susceptor material may comprise at least one of ferritic iron, ferromagnetic steel, stainless steel, and aluminium. Different materials will generate different amounts of heat when positioned within electromagnetic fields having similar values of frequency and field strength. Therefore, the susceptor material may be selected to provide a desired power dissipation within a known electromagnetic field.

In embodiments in which the susceptor material comprises stainless steel, the susceptor material may comprise at least one 400 series stainless steel. Suitable 400 series stainless steels include grade 410, grade 420, and grade 430.

The susceptor material may comprise a metallic wool. The metallic wool may be formed from any of the metallic susceptor materials described herein.

The susceptor material may comprise a metallic foam. The metallic foam may be formed from any of the metallic susceptor materials described herein.

The susceptor material may comprise a protective coating encapsulating the surface of the susceptor material. The protective coating may prevent direct contact between the susceptor material and the aerosol-forming substrate. Advantageously, this may prevent undesirable chemical reactions between the susceptor material and the aerosol-forming substrate. The protective coating may comprise at least one of a glass and a ceramic.

Preferably, each of the first particles does not comprise a susceptor material. Advantageously, providing first particles that are free of susceptor material may simplify the manufacture of the first particles.

Preferably, the aerosol-forming substrate comprises a solid aerosol-forming substrate.

Preferably, the aerosol-forming substrate comprises at least one of nicotine and tobacco. Preferably, the aerosol-forming substrate comprises nicotine.

As used herein with reference to the invention, the term “nicotine” is used to describe nicotine, a nicotine base or a nicotine salt. In embodiments in which the aerosol-forming substrate comprises a nicotine base or a nicotine salt, the amounts of nicotine recited herein are the amount of free base nicotine or amount of protonated nicotine, respectively.

The aerosol-forming substrate may comprise natural nicotine or synthetic nicotine.

The nicotine may comprise one or more nicotine salts. The one or more nicotine salts may be selected from the list consisting of nicotine lactate, nicotine citrate, nicotine pyruvate, nicotine bitartrate, nicotine benzoate, nicotine pectate, nicotine alginate, and nicotine salicylate.

The nicotine may comprise an extract of tobacco.

Preferably, the aerosol-forming substrate comprises at least 0.5 percent by weight of nicotine on a dry weight basis. More preferably, the aerosol-forming substrate comprises at least 1 percent by weight of nicotine on a dry weight basis. Even more preferably, the aerosol-forming substrate comprises at least 2 percent by weight of nicotine on a dry weight basis. In addition, or as an alternative, the aerosol-forming substrate preferably comprises less than 10 percent by weight of nicotine on a dry weight basis. More preferably, the aerosol-forming substrate comprises less than 8 percent by weight of nicotine on a dry weight basis. More preferably, the aerosol-forming substrate comprises less than 6 percent by weight of nicotine on a dry weight basis.

The aerosol-forming substrate may comprise one or more carboxylic acids. Advantageously, including one or more carboxylic acids in the aerosol-forming substrate may create a nicotine salt.

The one or more carboxylic acids comprise one or more of lactic acid and levulinic acid. Advantageously, the present inventors have found that lactic acid and levulinic acid are particularly good carboxylic acids for creating nicotine salts.

Preferably, the aerosol-forming substrate comprises at least 0.5 percent by weight of carboxylic acid, on a dry weight basis. More preferably, the aerosol-forming substrate comprises at least 1 percent by weight of carboxylic acid, on a dry weight basis. More preferably, the aerosol-forming substrate comprises at least 2 percent by weight of carboxylic acid, on a dry weight basis.

In addition, or as an alternative, the aerosol-forming substrate preferably comprises less than 15 percent by weight of carboxylic acid, on a dry weight basis. More preferably, the aerosol-forming substrate preferably comprises less than 10 percent by weight of carboxylic acid, on a dry weight basis. More preferably, the aerosol-forming substrate preferably comprises less than 5 percent by weight of carboxylic acid, on a dry weight basis. For example, the aerosol-forming substrate may comprise between 0.5 percent and 15 percent by weight of carboxylic acid, or between 1 percent and 10 percent by weight of carboxylic acid, or between 2 percent and 5 percent by weight of carboxylic acid.

The aerosol-forming substrate may comprise at least one aerosol former. The aerosol-forming substrate may comprise at least 15 percent by weight of aerosol former on a dry weight basis. Preferably, the aerosol-forming substrate comprises at least 20 percent by weight of aerosol former, on a dry weight basis. More preferably, the aerosol-forming substrate comprises at least 25 percent by weight of aerosol former, on a dry weight basis. More preferably, the aerosol-forming substrate comprises at least 30 percent by weight of aerosol former, on a dry weight basis. More preferably, the aerosol-forming substrate comprises at least 35 percent by weight of aerosol former, on a dry weight basis. More preferably, the aerosol-forming substrate comprises at least 40 percent by weight of aerosol former, on a dry weight basis. More preferably, the aerosol-forming substrate comprises at least 45 percent by weight of aerosol former, on a dry weight basis. More preferably, the aerosol-forming substrate comprises at least 50 percent by weight of aerosol former, on a dry weight basis.

Preferably, the aerosol-forming substrate comprises no more than 80 percent by weight on a dry weight basis. More preferably, the second aerosol-forming substrate comprises no more than 75 percent by weight on a dry weight basis. More preferably, the second aerosol-forming substrate comprises no more than 70 percent by weight on a dry weight basis.

Suitable aerosol formers for inclusion in the aerosol-forming substrate are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate.

The aerosol-forming substrate may comprise a gel composition that comprises nicotine, at least one gelling agent and aerosol former. The gel composition is preferably substantially tobacco free.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding.

The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding.

The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25 degrees Celsius, 50 percent by weight water/50 percent by weight glycerol mixture, in an amount of 0.3 percent by weight, increases the viscosity without leading to the formation of a gel, the mixture staying or remaining fluid.

The gel composition preferably includes the viscosifying agent in a range from about 0.2 percent by weight to about 5 percent by weight, or from about 0.5 percent by weight to about 3 percent by weight, or from about 0.5 percent by weight to about 2 percent by weight, or from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight.

The gel composition may further include an acid. The acid may comprise a carboxylic acid. The carboxylic acid may include a ketone group. Preferably the carboxylic acid may include a ketone group having less than about 10 carbon atoms, or less than about 6 carbon atoms or less than about 4 carbon atoms, such as levulinic acid or lactic acid. Preferably this carboxylic acid has three carbon atoms (such as lactic acid).

The gel composition preferably comprises some water. The gel composition is more stable when the composition comprises some water.

Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

The capsule outer wall may be formed of any suitable material. Preferably, the capsule outer wall is formed of an air impermeable material, most preferably an air impermeable polymeric material. This ensures that air does not pass through the capsule outer wall, other than in the holes provided specifically for airflow during use. The airflow through the capsule during use can therefore be effectively controlled.

The capsule outer wall may comprise a polymeric material or a cellulose-based material. For example, the capsule outer wall may be made of one or more polymers that are compatible with nicotine, including medical grade polymers such as ALTUGLAS® Medical Resins Polymethlymethacrylate (PMMA), Chevron Phillips K-Resin® Styrene-butadiene copolymer (SBC), Arkema special performance polymers Pebax®, Rilsan®, and Rilsan@ Clear, DOW (Health+™) Low-Density Polyethylene (LDPE), DOW™ LDPE 91003, DOW™ LDPE 91020 (MFI 2.0; density 923), ExxonMobil™ Polypropylene (PP) pp 1013H1, pp 1014H1 and pp 9074MED, Trinseo CALIBRE™ Polycarbonate (PC) 2060-SERIES.

The capsule outer wall may alternatively be formed from one or more materials selected from: polyethylene (PE), polypropylene (PP), polyvinylchloride (PVC), polyethylene terephthalate (PET), polylactic acid (PLA), cellulose acetate (CA), gelatin and hydroxypropyl methyl cellulose (HPMC).

The capsule is preferably capsule shaped, in the form of a sphero-cylinder, with a cylindrical portion defined by a cylindrical wall and rounded, hemispherical end walls at each end of the cylindrical portion. This type of capsule is commonly used in the pharmaceutical industry. Alternatively, the capsule may be spherical, or ovoid.

Preferably, the capsule is a two-part capsule, with two separate parts that fit together to close the capsule and retain the contents. The two separate parts may fit together by means of a friction fit, without adhesive. Alternatively, an adhesive may be used to seal the two parts together.

Preferably, the capsule comprises a first part and a second part, wherein the second part has a smaller outer diameter than the first part such that an end of the second part can be inserted into an open end of the first part in order to close the capsule. Preferably, when the capsule is mounted within the hollow tubular element, the second part of the capsule is provided downstream of the first part.

In such embodiments, the outer diameters of the first part and the second part of the capsule may be adapted such that only the second part of the capsule can be received within the hollow tubular element. The outer diameter of the first part of the capsule is adapted to be larger than the internal diameter of the hollow tubular element so that the first part of the capsule cannot be received within the hollow tubular element and remains outside of the hollow tubular element at the upstream end. Preferably, the second part of the capsule is retained within the hollow tubular element by means of a friction fit. The first part prevents the capsule from being pushed any further into the hollow tubular element.

Alternatively in such embodiments, the capsule may be fully inserted into the hollow tubular element and the outer diameters of the first part and the second part of the capsule may be adapted such that the outer diameter of the second part is smaller than the internal diameter of the hollow tubular element. This provides a space between the second part of the capsule and the wall of the hollow tubular element to enable airflow around the second part of the capsule. Such an arrangement may be beneficial in embodiments in which it is desired to position air outlets on the cylindrical wall of the capsule, as described below. The outer diameter of the first part of the capsule is preferably adapted such that the first part of the capsule is retained within the hollow tubular article by means of a friction fit. Alternatively, the first part of the capsule may be retained in place by means of a suitable adhesive. Either of these arrangements preferably substantially prevents airflow around the first part of the capsule, downstream from the second part of the capsule.

Preferably, the internal cavity of the capsule has a volume of at least 250 cubic millimetres, corresponding to 0.25 millimetres. This corresponds to the internal volume of the capsule, or the capacity. Preferably, the internal cavity of the capsule has a volume of at least 400 cubic millimetres (0.4 millilitres), more preferably at least 500 cubic millimetres (0.5 millilitres), more preferably at least 600 cubic millimetres (0.6 millilitres). The internal cavity of the capsule may be less than 2000 cubic millimetres (2 millilitres), or less than 1500 cubic millimetres (1.5 millilitres) or less than 1000 cubic millimetres (1 millilitre). For example, standard capsule sizes 000, 00, 0, 0, 1, 2 and 3 may be suitable.

The capsule preferably has a length of at least 10 millimetres, more preferably at least 12 millimetres, more preferably at least 15 millimetres, more preferably at least 18 millimetres. The length of the capsule is preferably less than 30 millimetres, more preferably less than 28 millimetres, more preferably less than 25 millimetres. For example, the capsule length may be between 10 millimetres and 30 millimetres, or between 12 millimetres and 28 millimetres, or between 15 millimetres and 25 millimetres, or between 18 millimetres and 25 millimetres. The capsule length may be around 20 millimetres.

The capsule preferably has a maximum diameter of at least 5 millimetres, more preferably at least 5.5 millimetres, more preferably at least 6 millimetres, more preferably at least 6.5 millimetres. The maximum diameter of the capsule is preferably less than 9 millimetres, more preferably less than 8.5 millimetres, more preferably less than 8 millimetres, more preferably less than 7.5 millimetres. For example, the capsule maximum diameter may be between 5 millimetres and 9 millimetres, or between 5.5 millimetres and 8.5 millimetres, or between 6 millimetres and 6 millimetres, or between 6.5 millimetres and 7.5 millimetres. The capsule maximum diameter may be around 7 millimetres.

The internal cavity of the capsule preferably contains at least 50 milligrams of the aerosol-forming substrate, more preferably at least 100 milligrams of the aerosol-forming substrate, more preferably at least 150 milligrams of the aerosol-forming substrate. The internal cavity may contain up to 1000 milligrams of the aerosol-forming substrate, or up to 750 milligrams of the aerosol-forming substrate, or up to 500 milligrams of the aerosol-forming substrate, or up to 250 milligrams of the aerosol-forming substrate. For example, the internal cavity of the capsule may contain between 50 milligrams and 1000 milligrams of the aerosol-forming substrate, or between 100 milligrams and 750 milligrams of the aerosol-forming substrate, or between 150 milligrams and 500 milligrams of the aerosol-forming substrate, or between 150 milligrams and 250 milligrams of the aerosol-forming substrate.

Preferably, the weight of the aerosol-forming substrate within the capsule corresponds to at least 0.1 milligrams per cubic millimetre of the internal cavity. This corresponds to the total weight of the aerosol-forming substrate, divided by the total volume of the internal cavity. Preferably, the weight of the aerosol-forming substrate within the capsule corresponds to at least 0.15 milligrams per cubic millimetre of the internal cavity, more preferably at least 0.2 milligrams per cubic millimetre of the internal cavity. The weight of the aerosol-forming substrate within the capsule may correspond to less than 2 milligrams per cubic millimetre of the internal cavity, or less than 1 milligram per cubic millimetre of the internal cavity, or less than 0.5 milligrams per cubic millimetre of the internal cavity. For example, the weight of the aerosol-forming substrate within the capsule may correspond to between 0.1 milligrams per cubic millimetre and 2 milligrams per cubic millimetre of the internal cavity, or between 0.15 milligrams per cubic millimetre and 1 milligram per cubic millimetre of the internal cavity, or between 0.2 milligrams per cubic millimetre and 0.5 milligrams per cubic millimetre of the internal cavity.

The percentage fill of the capsule by the first particles and the second particles, or the first particles and the single susceptor element, is preferably at least 50 percent, more preferably at least 60 percent, more preferably at least 70 percent. The percentage fill is preferably less than 90 percent. The percentage fill corresponds to the percentage of the internal cavity of the capsule that is occupied by the first particles and the second particles, or the first particles and the single susceptor element. In other words, the percentage fill corresponds to the percentage of the volume of the internal cavity that is occupied by the first particles and the second particles, or the first particles and the susceptor element. It may be advantageous to retain some empty space within the internal cavity to allow for air flow through the internal cavity and for the aerosol-forming substrate to be heated evenly.

The capsule may be configured such that one or more airflow pathways is provided through the capsule during heating. Advantageously, one or more airflow pathways enables the aerosol generated from the aerosol-forming substrate to be drawn through the aerosol-generating article and delivered to the consumer.

The capsule may be initially sealed and airtight but adapted such that airflow pathways are created when the aerosol-generating article is inserted into an aerosol-generating device, for example, through the insertion of an internal heating element or a piercing element which pierces the capsule outer wall.

Alternatively and preferably, the capsule comprises at least one air inlet and at least one air outlet in the capsule outer wall. Preferably, the at least one air inlet and the at least one air outlet define one or more airflow pathways through the internal cavity of the capsule between the at least one air inlet and the at least one air outlet. The at least one air outlet is provided downstream of the at least one air inlet.

Preferably, each of the first particles is larger than each of the at least one air inlet and the at least one air outlet. Advantageously, this may prevent the first particles being lost from the capsule through the at least one air inlet and the at least one air outlet.

Preferably, each of the second particles is larger than each of the at least one air inlet and the at least one air outlet. Advantageously, this may prevent the second particles being lost from the capsule through the at least one air inlet and the at least one air outlet.

Preferably, the capsule comprises a plurality of air inlets. For example, the capsule may comprise between 2 and 6 air inlets.

Preferably, the capsule comprises a plurality of air outlets. For example, the capsule may comprise between 2 and 6 air outlets. The number of air outlets may be the same as the number of air inlets, or different. It may be advantageous to provide a greater number of air outlets than air inlets, since the air outlets need to allow the aerosol generated within the capsule to pass out of the capsule into the hollow tubular element.

The number and size of the air inlets and air outlets may be adjusted in order to control the airflow through the capsule and also the resistance to draw (RTD) of the aerosol-generating article. In certain embodiments, the capsule will provide the main source of RTD within the article and the overall RTD of the aerosol-generating article is therefore likely to be very dependent on the RTD of the capsule.

Each air inlet and each air outlet is preferably in the form of a hole through the capsule outer wall. Preferably, each hole is cylindrical, although other shapes may also be suitable. The diameter of each hole should be sufficiently large that the hole cannot easily be blocked, for example, by dust. However, the diameter of each hole should also be adapted depending on the form and nature of the aerosol-forming substrate, so that the aerosol-forming substrate is not lost from the internal cavity, through the hole.

Preferably, each hole forming an air inlet or air outlet has a diameter of at least 0.2 millimetres, more preferably at least 0.25 millimetres, more preferably at least 0.3 millimetres, more preferably at least 0.35 millimetres, more preferably at least 0.4 millimetres, more preferably at least 0.5 millimetres. The diameter of each hole may be less than 2 millimetres, or less than 1.8 millimetres, or less than 1.7 millimetres, or less than 1.6 millimetres, or less than 1.5 millimetres, or less than 1.4 millimetres, or less than 1.3 millimetres, or less than 1.2 millimetres, or less than 1.1 millimetres, or less than 1 millimetre, or less than 0.9 millimetres, or less than 0.8 millimetres. For example, the diameter of each hole may be between 0.2 millimetres and 2 millimetres, or between 0.25 millimetres and 1.8 millimetres, or between 0.3 millimetres and 1.6 millimetres, or between 0.35 millimetres and 1.4 millimetres, or between 0.4 millimetres and 1.2 millimetres, or between 0.45 millimetres and 1 millimetres, or between 0.5 millimetres and 0.9 millimetres or between 0.5 millimetres and 0.8 millimetres.

Where a plurality of air inlets or air outlets is provided, the respective holes should be spaced apart sufficiently so that the presence of the holes does not adversely impact the structural integrity of the capsule. For example, the holes are preferably spaced at least 1 millimetre apart from each other.

The at least one air outlet is preferably at least 5 millimetres downstream of the at least one air inlet, more preferably at least 8 millimetres downstream of the at least one air inlet and more preferably at least 10 millimetres downstream of the at least one air inlet. This spacing enables the length of the airflow pathway through the capsule to be maximised.

The at least one air outlet is preferably positioned at the downstream end of the capsule. Where the capsule has a conventional capsule shape, with an elongate cylindrical body and rounded end walls, the at least one air outlet is preferably provided on the downstream end wall.

The at least one air inlet may be positioned at the upstream end of the capsule. For example, where the capsule has a conventional capsule shape as described above, the at least one air inlet may be provided on the upstream end wall. However, in certain embodiments it may be advantageous to position the at least one air inlet a certain distance downstream of the upstream end. For example, the at least one air inlet may be provided at least 2 millimetres downstream of the upstream end of the capsule, or at least 3 millimetres downstream of the upstream end of the capsule, or at least 4 millimetres downstream of the upstream end of the capsule, or at least 5 millimetres downstream of the upstream end of the capsule. Where a plurality of air inlets is provided, all of the air inlets should be provided at least this distance from the upstream end, even when the position of the air inlets along the length of the capsule varies.

In preferred embodiments, the capsule comprises a cylindrical wall and rounded end walls at the upstream and downstream ends of the cylindrical wall (as in a conventional capsule shape) and the at least one air inlet may advantageously be provided in the cylindrical wall, downstream of the upstream end wall.

This positioning of the at least one air inlet away from the upstream end of the capsule may be particularly beneficial when the aerosol-forming substrate is in the form of a gel composition or any other type of substrate that melts or becomes more viscous upon heating. By positioning the at least one air inlet away from the upstream end of the cavity, where the melted substrate may collect, this reduces or minimises the risk of the aerosol-forming substrate leaking from the capsule. The risk of blockage of the air inlets by the aerosol-forming substrate is also reduced or minimised.

The aerosol-generating article may comprise a hollow tubular element. The capsule may be positioned within the hollow tubular element. The capsule may be retained within the hollow tubular element by an interference fit.

The capsule may be positioned within the hollow tubular element so that the at least one air inlet is not covered or blocked by the wall of the hollow tubular element, in particular, where the at least one air inlet is provided on a cylindrical wall of the capsule, as described above. There are various suitable ways to achieve this, as described below.

The hollow tubular element may comprise one or more holes extending through a peripheral wall of the hollow tubular element, wherein the one or more holes are positioned to coincide with the one or more air inlets on the capsule. With such an arrangement, air can pass from outside of the hollow tubular element, through the peripheral wall of the hollow tubular element, and into the at least one air inlet.

The capsule may be mounted within the hollow tubular element such that a portion of the capsule extends from the upstream end of the hollow tubular element, so that the at least one air inlet is positioned outside of the hollow tubular element. Preferably, at least 20 percent of the length of the capsule protrudes from the hollow tubular element, more preferably at least 30 percent of the length of the capsule. Preferably, no more than 50 percent of the length of the capsule protrudes from the hollow tubular element. Preferably, a majority of the capsule is within the hollow tubular element so that the capsule may be retained securely within the hollow tubular element. The hollow tubular element may comprise a flange or protrusion extending inwards from the internal surface at the downstream end of the capsule, to prevent the capsule from being pushed downstream further into the hollow tubular element. For example, the hollow tubular element may comprise an annular flange extending from the internal surface.

The capsule may be provided with an outer diameter that is less than the internal diameter of the hollow tubular element. This arrangement provides a space between the outer surface of the capsule and the inner surface of the hollow tubular element, such that air can pass between the capsule and the hollow tubular element, to the at least one air inlet. In such embodiments, it may be necessary to block the flow of air from the upstream end of the hollow tubular element to the at least one air outlet in the capsule wall. In this way, the main airflow pathway is defined through the capsule and not around the outside of the capsule. This can be achieved, for example, by providing an annular sealing ring around the capsule, within the hollow tubular element, which seals the space between the capsule and the inner surface of the hollow tubular element at a position downstream of the at least one air inlet. Advantageously, the annular sealing ring also facilitates retention of the capsule within the hollow tubular element.

In such embodiments, the outer diameter of the capsule is preferably at least 0.2 millimetres less than the internal diameter of the hollow tubular element, more preferably at least 0.5 millimetres less than the internal diameter of the hollow tubular element, more preferably at least 0.8 millimetres less than the internal diameter of the hollow tubular element. The outer diameter of the capsule may be up to 2 millimetres less than the internal diameter of the hollow tubular element.

The inner surface of the hollow tubular element may be corrugated at the upstream end of the hollow tubular element to define a plurality of longitudinal channels that are circumferentially arranged to substantially coincide with the at least one air inlet. With such an arrangement, air can enter the hollow tubular element through the longitudinal channels defined by the corrugated surface and pass along the capsule to the at least one air inlet. The hollow tubular element is preferably corrugated along only a part of its length from the upstream end and not along the full length. The longitudinal channels therefore preferably extend to a position upstream of the at least one air outlet so that there is no flow of air from the upstream end of the hollow tubular element to the at least one air outlet. In this way, the main airflow pathway is defined through the capsule and not around the outside of the capsule.

Preferably, the hollow tubular element extends to the downstream end of the aerosol-generating article.

As used herein, the term “hollow tubular element” denotes a generally elongate element defining a lumen or channel along a longitudinal axis of the hollow tubular element. In particular, the term “tubular” is used herein with reference to a tubular element having a substantially cylindrical cross-section and defining at least channel extending between an upstream end of the tubular element and a downstream end of the tubular element. However, it will be understood that alternative geometries (for example, alternative cross-sectional shapes) of the tubular element may be possible.

The capsule may be positioned at the upstream end of the hollow tubular element, as described above. The hollow tubular element may define an empty cavity downstream of the capsule, wherein the empty cavity extends along a part or all of the length of the hollow tubular element. The empty cavity may extend from the capsule all of the way to the downstream end of the aerosol-generating article. In such embodiments, the aerosol-generating article can therefore be formed with only two elements: the capsule and the hollow tubular element. Alternatively, one or more filter segments may be provided within the hollow tubular element, at the downstream end of the hollow tubular element, or adjacent the downstream end of the hollow tubular element as described in more detail below.

The empty cavity defined within the hollow tubular element downstream of the capsule preferably has a length of at least 10 millimetres, more preferably at least 12 millimetres and more preferably at least 14 millimetres. The length of the empty cavity may be up to 40 millimetres, or up to 30 millimetres, or up to 25 millimetres. For example, the empty cavity may have a length of between 10 millimetres and 40 millimetres, or between 12 millimetres and 30 millimetres, or between 14 millimetres and 25 millimetres.

The hollow tubular element preferably has a total length of at least 25 millimetres, more preferably at least 28 millimetres, more preferably at least 30 millimetres, more preferably at least 32 millimetres, more preferably at least 34 millimetres. The length of the hollow tubular element may be less than 50 millimetres, or less than 48 millimetres, or less than 45 millimetres, or less than 42 millimetres or less than 40 millimetres. For example, the total length of the hollow tubular element may be between 25 millimetres and 50 millimetres, or between 28 millimetres and 48 millimetres, or between 30 millimetres and 45 millimetres, or between 32 millimetres and 42 millimetres, or between 34 millimetres and 40 millimetres.

The hollow tubular element may have an outer diameter of between 5 millimetres and 12 millimetres, for example of between 5 millimetres and 10 millimetres or of between 6 millimetres and 8 millimetres. In a preferred embodiment, the hollow tubular element has an external diameter of 7.2 millimetres plus or minus 10 percent.

The internal diameter of the hollow tubular element is preferably constant along the length of the hollow tubular element. The lumen or cavity of the hollow tubular element may have any cross-sectional shape. The lumen of the hollow tubular element may have a circular cross-sectional shape.

Preferably, the internal diameter of the hollow tubular element is at least 5 millimetres, more preferably at least 5.5 millimetres, more preferably at least 6 millimetres, more preferably at least 6.5 millimetres. The internal diameter of the hollow tubular element is preferably less than 9 millimetres, more preferably less than 8.5 millimetres, more preferably less than 8 millimetres, more preferably less than 7.5 millimetres. For example, the internal diameter may be between 5 millimetres and 9 millimetres, or between 5.5 millimetres and 8.5 millimetres, or between 6 millimetres and 6 millimetres, or between 6.5 millimetres and 7.5 millimetres. The internal diameter may be around 7 millimetres.

The hollow tubular element preferably has a wall thickness of at least 100 micrometres, more preferably at least 150 micrometres, more preferably at least 200 micrometres, more preferably at least 250 micrometres, more preferably at least 500 micrometres. The wall thickness of the hollow tubular element may be less than 2 millimetres, preferably less than 1.5 millimetres and even more preferably less than 1.25 mm. The wall thickness of the hollow tubular element may be less than 1 millimetre. For example, the wall thickness of the hollow tubular element may be between 100 micrometres and 2 millimetres, or between 150 micrometres and 1.5 millimetres, or between 200 micrometres and 1.25 millimetres, or between 250 micrometres and 1 millimetre, or between 500 micrometres and 1 millimetre.

The hollow tubular element may comprise a paper-based material. The hollow tubular element may comprise at least one layer of paper. The paper may be very rigid paper. The paper may be crimped paper, such as crimped heat resistant paper or crimped parchment paper. Advantageously, a crimped paper may form one or more airflow channels extending around the outside of the capsule. The one or more airflow channels may be particularly advantageous in embodiments in which the capsule comprises at least one of an air inlet and an air outlet on a cylindrical wall of the capsule.

Preferably, the hollow tubular element is formed from cardboard. The hollow tubular element may be a cardboard tube. Advantageously, cardboard is a cost-effective material that provides a balance between being deformable in order to provide ease of insertion of the article into an aerosol-generating device and being sufficiently stiff to provide suitable engagement of the article with the interior of the device. A cardboard tube may therefore provide suitable resistance to deformation or compression during use.

The hollow tubular element may be a paper tube. The hollow tubular element may be a tube formed from spirally wound paper. The hollow tubular element may be formed from a plurality of layers of the paper. The paper may have a basis weight of at least about 50 grams per square meter, at least about 60 grams per square meter, at least about 70 grams per square meter, or at least about 90 grams per square meter.

The hollow tubular element may comprise a polymeric material. For example, the hollow tubular element may comprise a polymeric film. The polymeric film may comprise a cellulosic film. The hollow tubular element may comprise low density polyethylene (LDPE) or polyhydroxyalkanoate (PHA) fibres. The hollow tube may comprise cellulose acetate tow.

Where the hollow tubular element comprises cellulose acetate tow, the cellulose acetate tow may have a denier per filament of between about 2 and about 4 and a total denier of between about 25 and about 40.

In aerosol-generating articles according to the present invention, the hollow tubular element preferably provides a negligible level of resistance to draw (RTD). The term “negligible level of RTD” is used to describe an RTD of less than 1 mm H₂O per 10 millimetres of length of the hollow tubular element or hollow tubular element, preferably less than 0.4 mm H₂O per 10 millimetres of length of the hollow tubular element or hollow tubular element, more preferably less than 0.1 mm H₂O per 10 millimetres of length of the hollow tubular element or hollow tubular element.

The RTD of the hollow tubular element is preferably less than or equal to about 10 millimetres H₂O. More preferably, the RTD of a hollow tubular element is less than or equal to about 5 millimetres H₂O. Even more preferably, the RTD of a hollow tubular element is less than or equal to about 2.5 millimetres H₂O. Even more preferably, the RTD of the hollow tubular element is less than or equal to about 2 millimetres H₂O. Even more preferably, the RTD of the hollow tubular element is less than or equal to about 1 millimetre H₂O.

The RTD of the hollow tubular element may be at least 0 millimetres H₂O, or at least about 0.25 millimetres H₂O or at least about 0.5 millimetres H₂O or at least about 1 millimetre H₂O.

In some embodiments, the RTD of the hollow tubular element is from about 0 millimetre H₂O to about 10 millimetres H₂O, preferably from about 0.25 millimetres H₂O to about 10 millimetres H₂O, preferably from about 0.5 millimetres H₂O to about 10 millimetres H₂O. In other embodiments, the RTD of the hollow tubular element is from about 0 millimetres H₂O to about 5 millimetres H₂O, preferably from about 0.25 millimetres H₂O to about 5 millimetres H₂O preferably from about 0.5 millimetres H₂O to about 5 millimetres H₂O. In other embodiments, the RTD of the hollow tubular element is from about 1 millimetre H₂O to about 5 millimetres H₂O. In further embodiments, the RTD of the hollow tubular element is from about 0 millimetres H₂O to about 2.5 millimetres H₂O, preferably from about 0.25 millimetres H₂O to about 2.5 millimetres H₂O, more preferably from about 0.5 millimetres H₂O to about 2.5 millimetres H₂O. In further embodiments, the RTD of the hollow tubular element is from about 0 millimetres H₂O to about 2 millimetres H₂O, preferably from about 0.25 millimetres H₂O to about 2 millimetres H₂O, more preferably from about 0.5 millimetres H₂O to about 2 millimetres H₂O. In a particularly preferred embodiment, the RTD of a hollow tubular element is about 0 millimetre H₂O.

The aerosol-generating article may comprise a downstream filter segment, as described above. The downstream filter segment may be mounted within the hollow tubular element at a downstream end of the hollow tubular element. The downstream filter segment may extend to the downstream end of the hollow tubular element. The downstream end of the downstream filter segment may define the downstream end of the aerosol-generating article. The inclusion of a downstream filter segment within the hollow tubular element may be useful to provide a desired level of RTD for the aerosol-generating article.

The downstream filter segment is located downstream of the capsule. Preferably, the capsule and the downstream filter segment are spaced apart in a longitudinal direction so that a cavity is defined between the capsule and the downstream filter segment. Preferably, the downstream filter segment is located at least 5 millimetres downstream from the downstream end of the capsule, more preferably at least 8 millimetres downstream from the downstream end of the capsule, more preferably at least 10 millimetres downstream from the downstream end of the capsule, more preferably at least 15 millimetres downstream from the downstream end of the capsule. Preferably, the downstream filter segment is located less than 30 millimetres downstream from the downstream end of the capsule, more preferably less than 25 millimetres downstream from the downstream end of the capsule. The distance defined between the downstream end of the capsule and the downstream filter segment corresponds to the length of the cavity between the capsule and the downstream filter segment.

The downstream filter segment is preferably a solid plug, which may also be described as a ‘plain’ plug and is non-tubular. The filter segment preferably has a substantially uniform transverse cross section.

The downstream filter segment is preferably formed of a fibrous filtration material. The fibrous filtration material may be for filtering the aerosol that is generated from the aerosol-forming substrate. Suitable fibrous filtration materials would be known to the skilled person. Particularly preferably, the at least one downstream filter segment comprises a cellulose acetate filter segment formed of cellulose acetate tow.

The downstream filter segment may optionally comprise a flavourant, which may be provided in any suitable form. For example, the downstream filter segment may comprise one or more capsules, beads or granules of a flavourant, or one or more flavour loaded threads or filaments.

Preferably, the downstream filter segment has a low particulate filtration efficiency.

The downstream filter segment preferably has an external diameter that is approximately equal to the internal diameter of the hollow tubular element, so that the downstream filter segment is retained within the hollow tubular element by means of a friction fit.

Preferably, the external diameter of the downstream filter segment is between 5 millimetres and 12 millimetres, more preferably between 6 millimetres and 10 millimetres, more preferably between 7 millimetres and 8 millimetres.

Unless otherwise specified, the resistance to draw (RTD) of a component or the aerosol-generating article is measured in accordance with ISO 6565-2015. The RTD refers the pressure required to force air through the full length of a component. The terms “pressure drop” or “draw resistance” of a component or article may also refer to the “resistance to draw”. Such terms generally refer to the measurements in accordance with ISO 6565-2015 that are normally carried out at under test at a volumetric flow rate of 17.5 millilitres per second at the output or downstream end of the measured component at a temperature of 22 degrees Celsius, a pressure of 101 kPa (about 760 Torr) and a relative humidity of 60 percent. Conditions for smoking and smoking machine specifications are set out in ISO Standard 3308 (ISO 3308:2000). Atmosphere for conditioning and testing are set out in ISO Standard 3402 (ISO 3402:1999).

The resistance to draw (RTD) of the downstream filter segment may be at least 0 millimetres H₂O, or at least 3 millimetres H₂O, or at least 6 millimetres H₂O.

The RTD of the downstream filter segment may be no greater than 12 millimetres H₂O, or no greater than 11 millimetres H₂O, or no greater than 10 millimetres H₂O.

As mentioned above, the downstream filter segment may be formed of a fibrous filtration material. The downstream filter segment may be formed of a porous material. The downstream filter segment may be formed of a biodegradable material. The downstream filter segment may be formed of a cellulose material, such as cellulose acetate. For example, the downstream filter segment may be formed from a bundle of cellulose acetate fibres having a denier per filament between 10 and 15. For example, the downstream filter segment formed from relatively low-density cellulose acetate tow, such as cellulose acetate tow comprising fibres of 12 denier per filament.

The downstream filter segment may be formed of a polylactic acid-based material. The downstream filter segment may be formed of a bioplastic material, preferably a starch-based bioplastic material. The downstream filter segment may be made by injection moulding or by extrusion. Bioplastic-based materials are advantageous because they are able to provide downstream filter segment structures which are simple and cheap to manufacture with a particular and complex cross-sectional profile, which may comprise a plurality of relatively large air flow channels extending through the downstream filter segment material, that provides suitable RTD characteristics.

The length of the downstream filter segment may be at least 5 millimetres, or at least 8 millimetres, or at least 10 millimetres. The length of the downstream filter segment may be less than 20 millimetres, or less than 15 millimetres, or less than 12 millimetres. For example, the length of the downstream filter segment may be between 5 millimetres and 20 millimetres, or between 8 millimetres and 15 millimetres, or between 8 millimetres and 12 millimetres, or between 10 millimetres and 12 millimetres.

The downstream filter segment may be provided downstream of the hollow tubular element. The downstream filter segment may extend between the hollow tubular element and the downstream end of the aerosol-generating article. The downstream filter segment may be connected to the hollow tubular element by means of a tipping wrapper.

The overall RTD of the aerosol-generating article may be at least 1 millimetre H₂O. For example, the overall RTD of the aerosol-generating article may be at least 2 millimetres H₂O, at least 3 millimetres H₂O, at least 4 millimetres H₂O, at least 5 millimetres H₂O, at least 6 millimetres H₂O, at least 7 millimetres H₂O, at least 8 millimetres H₂O, at least 9 millimetres H₂O, at least 10 millimetres H₂O, at least 15 millimetres H₂O, at least 20 millimetres H₂O, at least 30 millimetres H₂O, at least 40 millimetres H₂O, or at least 50 millimetres H₂O.

The overall RTD of the aerosol-generating article may be no more than 180 millimetres H₂O. For example, the overall RTD of the aerosol-generating article may be no more than 170 millimetres H₂O, no more than 160 millimetres H₂O, no more than 150 millimetres H₂O, or no more than 140 millimetres H₂O.

The overall RTD of the aerosol-generating article may be between 1 millimetre H₂O and 180 millimetres H₂O. For example, the overall RTD of the aerosol-generating article may be between 5 millimetres H₂O and 170 millimetres H₂O, between 10 millimetres H₂O and 160 millimetres H₂O, between 20 millimetres H₂O and 150 millimetres H₂O, or between 50 millimetres H₂O and 140 millimetres H₂O.

The aerosol-generating article may have an overall length of at least 40 millimetres, or at least 50 millimetres, or at least 60 millimetres.

The overall length of the aerosol-generating article may be less than or equal to 90 millimetres, or less than or equal to 85 millimetres, or less than or equal to 80 millimetres.

In some embodiments, the overall length of the aerosol-generating article is preferably from 40 millimetres to 70 millimetres, more preferably from 45 millimetres to 70 millimetres. In other embodiments, the overall length of the aerosol-generating article is preferably from 40 millimetres to 60 millimetres, more preferably from about 45 millimetres to about 60 millimetres. In further embodiments, the overall length of the aerosol-generating article is preferably from 40 millimetres to 50 millimetres, more preferably from 45 millimetres to 50 millimetres. In an exemplary embodiment, the overall length of the aerosol-generating article is about 45 millimetres.

The aerosol-generating article may have an external diameter of at least 5 millimetres, or at least 6 millimetres, or at least 7 millimetres.

The aerosol-generating article may have an external diameter of less than or equal to about 12 millimetres, or less than or equal to about 10 millimetres, or less than or equal to about 8 millimetres.

In some embodiments, the aerosol-generating article has an external diameter from about 5 millimetres to about 12 millimetres, preferably from about 6 millimetres to about 12 millimetres, more preferably from about 7 millimetres to about 12 millimetres. In other embodiments, the aerosol-generating article has an external diameter from about 5 millimetres to about 10 millimetres, preferably from about 6 millimetres to about 10 millimetres, more preferably from about 7 millimetres to about 10 millimetres. In further embodiments, the aerosol-generating article has an external diameter from about 5 millimetres to about 8 millimetres, preferably from about 6 millimetres to about 8 millimetres, more preferably from about 7 millimetres to about 8 millimetres. In other embodiments, the aerosol-generating article has an external diameter of less than 7 millimetres.

The external diameter of the aerosol-generating article may be substantially constant over the whole length of the article. As an alternative, different portions of the aerosol-generating article may have different external diameters.

The present invention also relates to an aerosol-generating system comprising an aerosol-generating article according to the invention, in accordance with any of the embodiments described herein. The aerosol-generating system also comprises an aerosol-generating device comprising a device cavity for receiving the aerosol-generating article and an inductive heating arrangement for inductively heating the plurality of second particles of the single susceptor element.

The aerosol-generating device may have a distal end and a mouth end opposite the distal end. The aerosol-generating device may comprise a housing. The housing of the aerosol-generating device may define the device cavity. Preferably, the device cavity is positioned at the mouth end of the aerosol-generating device.

The device cavity may be referred to as a heating chamber of the aerosol-generating device. The device cavity may extend between a distal end and a mouth, or proximal, end. The distal end of the device cavity may be a closed end and the mouth, or proximal, end of the device cavity may be an open end. The aerosol-generating article may be inserted into the device cavity via the open end of the device cavity. The device cavity may be cylindrical in shape to conform to the same shape of the aerosol-generating article.

The expression “received within” may refer to the fact that a component or element is fully or partially received within another component or element. For example, the expression “aerosol-generating article is received within the device cavity” refers to the aerosol-generating article being fully or partially received within the device cavity of the aerosol-generating article. When the aerosol-generating article is received within the device cavity, the aerosol-generating article may abut the distal end of the device cavity. When the aerosol-generating article is received within the device cavity, the aerosol-generating article may be in substantial proximity to the distal end of the device cavity. The distal end of the device cavity may be defined by an end-wall. When the aerosol-generating article is received within the device cavity, a mouth end of the aerosol-generating article may protrude from the mouth end of the device cavity.

The length of the device cavity may be between 15 millimetres and 80 millimetres, or between 20 millimetres and 70 millimetres, or between 25 millimetres and 60 millimetres, or between 25 millimetres and 50 millimetres.

The length of the device cavity may be between 25 millimetres and 29 millimetres, or between 26 millimetres and 29 millimetres, or between 27 millimetres or 28 millimetres.

When the aerosol-generating article is received within the device cavity, the capsule is preferably fully within the device cavity to optimise the heating of the aerosol-forming substrate within the capsule. Therefore, the length of the device cavity is preferably greater than the length of the capsule.

A diameter of the device cavity may be between 4 millimetres and 10 millimetres. A diameter of the device cavity may be between 5 millimetres and 9 millimetres. A diameter of the device cavity may be between 6 millimetres and 8 millimetres. A diameter of the device cavity may be between 6 millimetres and 7 millimetres.

A diameter of the device cavity may be substantially the same as or greater than a diameter of the aerosol-generating article. A diameter of the device cavity may be the same as a diameter of the aerosol-generating article to establish a tight fit with the aerosol-generating article.

The device cavity may be configured to establish a tight fit with the aerosol-generating article received within the device cavity. Tight fit may refer to a snug fit. The aerosol-generating device may comprise a peripheral wall. Such a peripheral wall may define the device cavity, or heating chamber. The peripheral wall defining the device cavity may be configured to engage with the aerosol-generating article received within the device cavity in a tight fit manner, so that there is substantially no gap or empty space between the peripheral wall defining the device cavity and the aerosol-generating article when received within the device.

Such a tight fit may establish an airtight fit or configuration between the device cavity and the aerosol-generating article received therein.

With an airtight configuration, there is substantially no gap or empty space between the peripheral wall defining the device cavity and the aerosol-generating article for air to flow through.

The tight fit with an aerosol-generating article may be established along the entire length of the device cavity or along a portion of the length of the device cavity.

The aerosol-generating device may comprise an air-flow channel extending between a channel inlet and a channel outlet. The air-flow channel may be configured to establish a fluid communication between the interior of the device cavity and the exterior of the aerosol-generating device. The air-flow channel of the aerosol-generating device may be defined within the housing of the aerosol-generating device to enable fluid communication between the interior of the device cavity and the exterior of the aerosol-generating device. When the aerosol-generating article is received within the device cavity, the air-flow channel may be configured to provide air flow into the article in order to deliver generated aerosol to a user drawing from the mouth end of the article.

The air-flow channel of the aerosol-generating device may be defined within, or by, the peripheral wall of the housing of the aerosol-generating device. In other words, the air-flow channel of the aerosol-generating device may be defined within the thickness of the peripheral wall or by the inner surface of the peripheral wall, or a combination of both. The air-flow channel may partially be defined by the inner surface of the peripheral wall and may be partially defined within the thickness of the peripheral wall. The inner surface of the peripheral wall defines a peripheral boundary of the device cavity.

The air-flow channel of the aerosol-generating device may extend from an inlet located at the mouth end, or proximal end, of the aerosol-generating device to an outlet located away from mouth end of the device. The air-flow channel may extend along a direction parallel to the longitudinal axis of the aerosol-generating device.

The inductive heating arrangement may comprise an inductor coil and a power supply configured to provide high frequency oscillating current to the inductor coil. As used herein, a “high frequency oscillating current” means an oscillating current having a frequency of between about 500 kHz and about 30 MHz. The aerosol-generating device may comprise a DC/AC inverter for converting a DC current supplied by a DC power supply to the alternating current. The inductor coil may be arranged to generate a high frequency oscillating electromagnetic field on receiving the high frequency oscillating current from the power supply. During use, the high frequency oscillating electromagnetic field inductively heats the susceptor material of the aerosol-generating article. Preferably, the inductor coil is arranged to generate the high frequency oscillating electromagnetic field in the device cavity. The inductor coil may substantially circumscribe the device cavity. The inductor coil may extend at least partially along the length of the device cavity.

During use, the inductive heating arrangement may be controlled to heat the susceptor material within a defined operating temperature range, below a maximum operating temperature. An operating temperature range between about 150 degrees Celsius and about 300 degrees Celsius in the heating chamber (or device cavity) is preferable. The operating temperature range of the heater may be between about 150 degrees Celsius and about 250 degrees Celsius.

The aerosol-generating device may comprise a power supply. The power supply may be a DC power supply. In some embodiments, the power supply is a battery. The power supply may be a nickel-metal hydride battery, a nickel cadmium battery, or a lithium-based battery, for example a lithium-cobalt, a lithium-iron-phosphate or a lithium-polymer battery. However, in some embodiments the power supply may be another form of charge storage device, such as a capacitor. The power supply may require recharging and may have a capacity that allows for the storage of enough energy for one or more user operations, for example one or more aerosol-generating experiences.

The aerosol-generating device may comprise a piercing device for piercing the capsule when the aerosol-generating article is inserted into the device cavity. As described above, the piercing of the capsule may be necessary in order to establish one or more airflow pathways through the capsule.

The present invention also relates to a method of forming a capsule for an aerosol-generating article for generating an inhalable aerosol upon heating. The method comprises providing a plurality of first particles each comprising an aerosol-forming substrate, and providing a plurality of second particles each comprising a susceptor material and no aerosol-forming substrate. The method further comprises mixing the plurality of first particles with the plurality of second particles to form a particle mixture. The method also comprises providing a capsule outer wall defining an internal cavity, and inserting the particle mixture into the internal cavity to form a capsule comprising the capsule outer wall and the particle mixture within the internal cavity. The capsule may comprise any of the preferred or optional features of capsules described above.

The present invention also relates to another method of forming a capsule for an aerosol-generating article for generating an inhalable aerosol upon heating. The method comprises providing a plurality of first particles each comprising an aerosol-forming substrate, and providing a single susceptor element. The method further comprises providing a capsule outer wall defining an internal cavity, and inserting the plurality of first particles and the single susceptor element into the internal cavity to form a capsule comprising the capsule outer wall and the plurality of first particles and the single susceptor element within the internal cavity. The capsule may comprise any of the preferred or optional features of capsules described above.

Below, there is provided a non-exhaustive list of non-limiting examples. Any one or more of the features of these examples may be combined with any one or more features of another example, embodiment, or aspect described herein.

Example 1: An aerosol-generating article for generating an inhalable aerosol upon heating, the aerosol-generating article comprising a capsule, the capsule comprising:
a capsule outer wall defining an internal cavity; and
a plurality of first particles within the internal cavity, each of the first particles comprising an aerosol-forming substrate;
wherein the capsule further comprises only one of the following:
   a plurality of second particles within the internal cavity, each of the second particles comprising a susceptor material and no aerosol-forming substrate; or
   a single susceptor element within the internal cavity.

Example 2: An aerosol-generating article according to Example 1, wherein the capsule comprises the plurality of second particles.

Example 3: An aerosol-generating article according to Example 2, wherein the plurality of second particles is mixed with the plurality of first particles.

Example 4: An aerosol-generating article according to Example 2 or 3, wherein each of the first particles has an outer surface comprising a first shape, wherein each of the second particles has an outer surface comprising a second shape, and wherein part of the second shape is configured to engage with part of the first shape.

Example 5: An aerosol-generating article according to Example 4, wherein part of the first shape is configured to receive part of the second shape.

Example 6: An aerosol-generating article according to Example 4 or 5, wherein part of the second shape is configured to receive part of the first shape.

Example 7: An aerosol-generating article according to any of Examples 2 to 6, wherein each of the first particles has a first cross-sectional dimension, wherein each of the second particles has a second cross-sectional dimension, and wherein the first cross-sectional dimension and the second cross-sectional dimension are the same.

Example 8: An aerosol-generating article according to Example 7, wherein each of the first particles has a spherical shape, wherein each of the second particles has a spherical shape, wherein the first cross-sectional dimension is a diameter of each of the first particles and wherein the second cross-sectional dimension is a diameter of each of the second particles.

Example 9: An aerosol-generating article according to any of Examples 2 to 8, wherein each of the first particles has a first mass, wherein each of the second particles has a second mass, and wherein the first mass and the second mass are the same.

Example 10: An aerosol-generating article according to any of Examples 2 to 9, wherein each of the first particles has a first density, wherein each of the second particles has a second density, and wherein the first density and the second density are the same.

Example 11: An aerosol-generating article according to any of Examples 2 to 10, wherein a ratio of the total number of first particles to the total number of second particles is between 0.9 to 1 and 1.1 to 1.

Example 12: An aerosol-generating article according to any of Examples 2 to 11, wherein each of the second particles has a homogenous structure.

Example 13: An aerosol-generating article according to any of Examples 2 to 11, wherein each of the second particles has a heterogenous structure.

Example 14: An aerosol-generating article according to any of Examples 2 to 11, wherein each of the second particles comprises a plurality of layers of susceptor material.

Example 15: An aerosol-generating article according to Examples 14, wherein the plurality of layers of susceptor material comprises a first layer comprising a first susceptor material and a second layer comprising a second susceptor material, wherein the first susceptor material is different to the second susceptor material.

Example 16: An aerosol-generating article according to any of Examples 2 to 15, wherein each of the second particles has a non-uniform density.

Example 17: An aerosol-generating article according to any of Examples 2 to 16, wherein each of the second particles comprises a shell of susceptor material.

Example 18: An aerosol-generating article according to Example 17, wherein the shell of susceptor material defines a void inside the shell of susceptor material.

Example 19: An aerosol-generating article according to Example 18, wherein the void is filled with one of air, an inert gas, a partial vacuum, and a vacuum.

Example 20: An aerosol-generating article according to Example 18, wherein the void is filled with a non-susceptor material.

Example 21: An aerosol-generating article according to Example 20, wherein the shell of susceptor material has a first density, wherein the non-susceptor material has a second density, and wherein the second density is less than the first density.

Example 22: An aerosol-generating article according to Examples 20 or 21, wherein the non-susceptor material comprises a non-conductive foam.

Example 23: An aerosol-generating article according to any of Examples 2 to 22, wherein each of the second particles has at least one of a size and a shape to increase a surface area of the second particle.

Example 24: An aerosol-generating article according to any of Examples 2 to 23, wherein each of the second particles comprises a plurality of fins.

Example 25: An aerosol-generating article according to Example 24, wherein each fin is formed from the susceptor material.

Example 26: An aerosol-generating article according to Example 24 or 25, wherein each of the second particles comprises a plurality of discs, and wherein each disc forms one of the plurality of fins.

Example 27: An aerosol-generating article according to Example 26, wherein the discs are arranged in a stack.

Example 28: An aerosol-generating article according to Examples 27, wherein the discs are connected to each other by a central column.

Example 29: An aerosol-generating article according to Example 28, wherein the central column is formed from the susceptor material.

Example 30: An aerosol-generating article according to any of Examples 26 to 29, wherein the discs are spaced apart from each other.

Example 31: An aerosol-generating article according to any of Examples 2 to 30, wherein each of the second particles has at least one of a size and a shape to minimise interlocking of the second particles with each other.

Example 32: An aerosol-generating article according to any of Examples 2 to 31, wherein each of the second particles has at least one of a size and a shape to maximise contact between the second particles and the first particles.

Example 33: An aerosol-generating article according to any of Examples 2 to 32, wherein each of the first particles has a first size, wherein each of the second particles has a second size, and wherein the second size is different to the first size.

Example 34: An aerosol-generating article according to any of Examples 2 to 32, wherein each of the first particles has a first size, wherein each of the second particles has a second size, and wherein the second size is the same as the first size.

Example 35: An aerosol-generating article according to any of Examples 2 to 34, wherein each of the first particles has a first shape, wherein each of the second particles has a second shape, and wherein the second shape is different to the first shape.

Example 36: An aerosol-generating article according to any of Examples 2 to 34, wherein each of the first particles has a first shape, wherein each of the second particles has a second shape, and wherein the second shape is the same as the first shape.

Example 37: An aerosol-generating article according to any of Examples 2 to 36, wherein each of the first particles has a first mass, wherein each of the second particles has a second mass, and wherein a difference between the first mass and the second mass is less than 10 percent of the first mass.

Example 38: An aerosol-generating article according to any of Examples 2 to 37, wherein each of the first particles has a first density, wherein each of the second particles has a second density, and wherein a difference between the first density and the second density is less than 10 percent of the first density.

Example 39: An aerosol-generating article according to any preceding Example, wherein each of the first particles has a convex shape.

Example 40: An aerosol-generating article according to any preceding Example, wherein each of the first particles has a spherical shape, an ellipsoidal shape, or an ovoid shape. Example 41: An aerosol-generating article according to any of Examples 2 to 40, wherein each of the second particles has a convex shape.

Example 42: An aerosol-generating article according to any of Examples 2 to 41, wherein each of the second particles has a spherical shape, an ellipsoidal shape, or an ovoid shape.

Example 43: An aerosol-generating article according to any of Examples 2 to 40, wherein each of the second particles has a stellated polyhedral shape.

Example 44: An aerosol-generating article according to Example 1, wherein the capsule comprises the single susceptor element, and wherein the single susceptor element comprises a susceptor material.

Example 45: An aerosol-generating article according to any preceding Example, wherein the susceptor material comprises at least one metal.

Example 46: An aerosol-generating article according to any preceding Example, wherein the susceptor material comprises at least one metal alloy.

Example 47: An aerosol-generating article according to any preceding Example, wherein the susceptor material comprises a foam.

Example 48: An aerosol-generating article according to any preceding Example, wherein each of the first particles does not comprise a susceptor material.

Example 49: An aerosol-generating article according to any preceding Example, wherein the aerosol-forming substrate comprises a solid aerosol-forming substrate.

Example 50: An aerosol-generating article according to any preceding Example, wherein the aerosol-forming substrate comprises at least one of tobacco and nicotine.

Example 51: An aerosol-generating article according to any preceding Example, wherein the capsule outer wall is formed of an air impermeable material.

Example 52: An aerosol-generating article according to any preceding Example, wherein the capsule comprises at least one air inlet extending through the capsule outer wall and at least one air outlet extending through the capsule outer wall.

Example 53: An aerosol-generating article according to Example 52, wherein the at least one air inlet and the at least one air outlet are positioned to define at least one airflow pathway through the internal cavity between the at least one air inlet and the at least one air outlet.

Example 54: An aerosol-generating article according to Example 52 or 53, wherein each of the first particles is larger than each of the at least one air inlet and the at least one air outlet.

Example 55: An aerosol-generating article according to Example 52, 53 or 54, in combination with Example 2, wherein each of the second particles is larger than each of the at least one air inlet and the at least one air outlet.

Example 56: An aerosol-generating article according to any preceding Example, wherein the internal cavity of the capsule has a volume, and wherein the first particles and the second particles or the single susceptor element together occupy at least 70 percent of the volume of the internal cavity.

Example 57: An aerosol-generating article according to any preceding claim, further comprising a hollow tubular element, wherein the capsule is positioned within the hollow tubular element.

Example 58: An aerosol-generating article according to Example 57, wherein the capsule is positioned at an upstream end of the hollow tubular element.

Example 59: An aerosol-generating article according to Example 57 or 58, wherein the hollow tubular element is formed from at least one of paper and cardboard.

Example 60: An aerosol-generating article according to Example 57, 58 or 59, wherein the capsule is retained within the hollow tubular element by an interference fit.

Example 61: An aerosol-generating article according to any of Examples 57 to 60, further comprising a filter element positioned downstream of the hollow tubular element.

Example 62: An aerosol-generating article according to Example 61, wherein the filter element is positioned adjacent a downstream end of the hollow tubular element.

Example 63: An aerosol-generating article according to Example 61 or 62, wherein the filter element is positioned at a downstream end of the aerosol-generating article.

Example 64: An aerosol-generating article according to Example 61, 62 or 63, wherein the filter element is spaced apart from the capsule to define a cavity between the capsule and the filter element.

Example 65: An aerosol-generating system comprising:
an aerosol-generating article according to any preceding Example; and
an aerosol-generating device comprising:
   a device cavity for receiving at least a portion of the aerosol-generating article; and
   an inductive heating arrangement for inductively heating the plurality of second particles or the single susceptor element.

Example 66: A method of forming a capsule for an aerosol-generating article for generating an inhalable aerosol upon heating, the method comprising:
providing a plurality of first particles each comprising an aerosol-forming substrate;
providing a plurality of second particles each comprising a susceptor material and no aerosol-forming substrate;
mixing the plurality of first particles with the plurality of second particles to form a particle mixture;
providing a capsule outer wall defining an internal cavity; and
inserting the particle mixture into the internal cavity to form a capsule comprising the capsule outer wall and the particle mixture within the internal cavity.

Example 67: A method of forming a capsule for an aerosol-generating article for generating an inhalable aerosol upon heating, the method comprising:
providing a plurality of first particles each comprising an aerosol-forming substrate;
providing a single susceptor element;
providing a capsule outer wall defining an internal cavity; and
inserting the plurality of first particles and the single susceptor element into the internal cavity to form a capsule comprising the capsule outer wall and the plurality of first particles and the single susceptor element within the internal cavity.

Example 68: A method according to Example 66 or Example 67, wherein the capsule is a capsule comprising the features of any of Examples 1 to 64.

The invention will be further described with reference to the accompanying drawings in which:

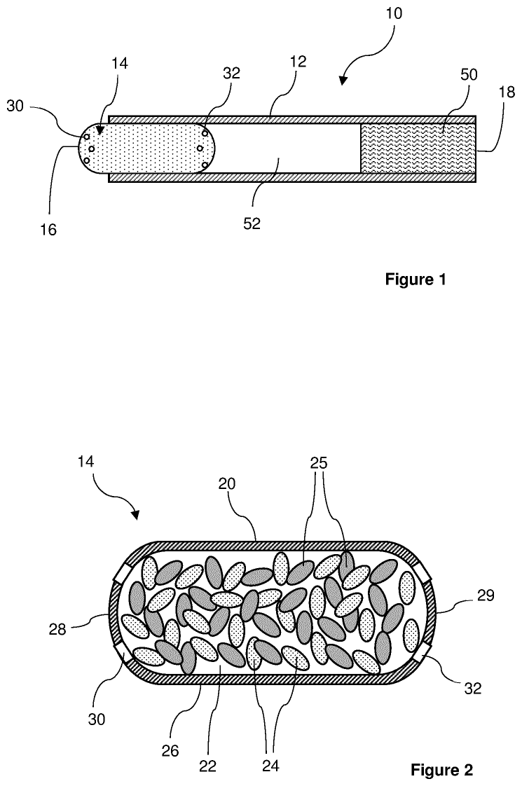

FIG. 1 shows a cross-sectional view of an aerosol-generating article according to an embodiment of the present invention;

FIG. 2 shows a cross-sectional view of the capsule of the aerosol-generating article of FIG. 1;

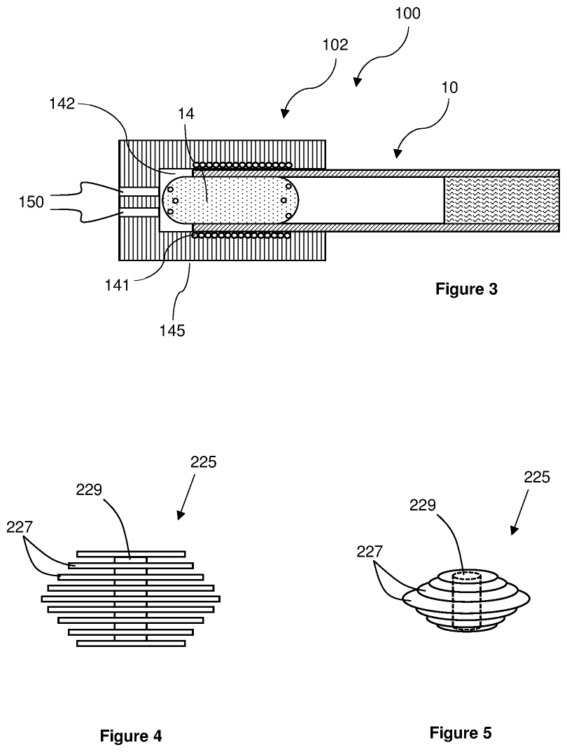

FIG. 3 shows a cross-sectional view of an aerosol-generating system comprising an aerosol-generating device and the aerosol-generating article of FIG. 1 received within the aerosol-generating device;

FIG. 4 shows a cross-sectional view of an alternative second particle for the capsule of FIG. 2;

FIG. 5 shows a perspective view of the second particle of FIG. 4;

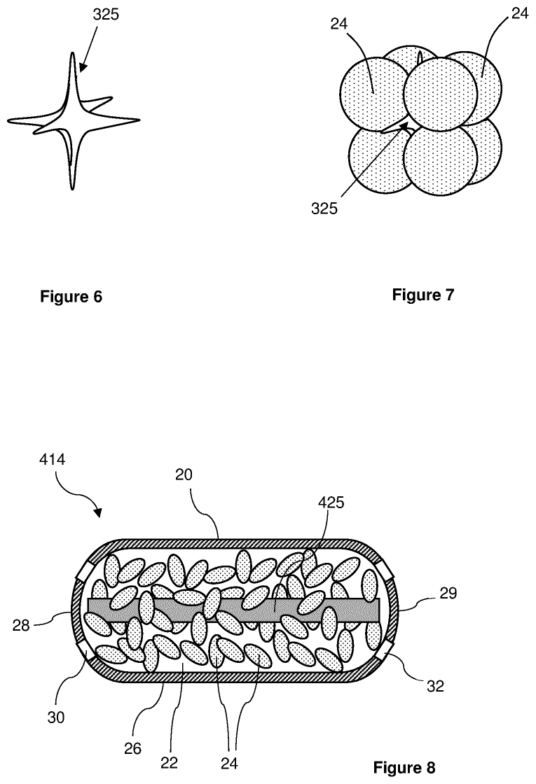

FIG. 6 shows a perspective view of a further alternative second particle for the capsule of FIG. 2;

FIG. 7 shows a perspective view of the second particle of FIG. 6 nested with a plurality of first particles each having a spherical shape; and

FIG. 8 shows a cross-sectional view of an alternative capsule for the aerosol-generating article of FIG. 1.

FIG. 1 shows an aerosol-generating article 10 comprising a hollow tubular element 12 and a capsule 14 mounted at the upstream end of the hollow tubular element 12. The aerosol-generating article 10 extends from an upstream or distal end 16 to a downstream or mouth end 18. The upstream end 16 coincides with an upstream end of the capsule 14. The downstream end 18 coincides with a downstream end of the hollow tubular element 12.

The aerosol-generating article 10 has an overall length of about 45 millimetres and an external diameter of about 7.2 mm.

The hollow tubular element 12 is formed of a cylindrical cardboard tube having a wall thickness of approximately 0.25 millimetres. The hollow tubular element 12 defines an internal channel. The hollow tubular element 12 has a length of about 45 millimetres, an external diameter of about 7.2 millimetres and an internal diameter of about 6.7 millimetres. The capsule 14 is mounted within the internal channel of the hollow tubular element 12 at the upstream end.

FIG. 2 shows a more detailed cross-sectional view of a suitable capsule 14 for use in the aerosol-generating article 10 of FIG. 1.

The capsule 14 is a two-part capsule formed of an air impermeable polymer such as HPMC. The capsule 14 has an elongate, capsule (sphero-cylindrical) shape with a round cross section. The capsule comprises a capsule outer wall 20 defining an internal cavity 22 that contains a plurality of first particles 24 and a plurality of second particles 25 mixed with the plurality of first particles 24. Each of the first particles 24 comprises an aerosol-forming substrate which is a solid aerosol-forming substrate comprising nicotine. Each of the second particles 25 comprises a susceptor material comprising stainless steel. The capsule outer wall 20 is defined by a cylindrical wall 26 and opposed hemispherical end walls 28, 29, which are integrally formed with the cylindrical wall 26. The capsule 14 has a length of about 20 millimetres and an external diameter of about 6.7 millimetres. The external diameter of the capsule 14 is therefore similar to the internal diameter of the hollow tubular element 12 such that the capsule is retained within the hollow tubular element 12 by means of a friction fit.

The downstream filter segment 50 is spaced apart from the capsule 14 to define an empty cavity 52 inside the hollow tubular element 12. The empty cavity 52 has a length of about 25 millimetres. The downstream filter segment 50 extends to the downstream end of the hollow tubular element 12 such that the downstream end of the downstream filter segment 50 substantially coincides with the downstream end 18 of the aerosol-generating article 10.

The downstream filter segment 50 has a length of about 10 millimetres and comprises a low-density, cellulose acetate filter segment. The RTD of the downstream filter segment 50 is about 10 mm H₂O.

The capsule 14 is mounted within the hollow tubular element 12 such that approximately 30 percent of the capsule 14 extends beyond the upstream end of the hollow tubular element 12. The capsule 14 therefore protrudes from the upstream end of the hollow tubular element 12 and the upstream end of the capsule 14 defines the upstream end 16 of the aerosol-generating article 10.

The capsule has an internal volume of about 600 cubic millimetres and contains about 200 milligrams of the aerosol-forming substrate. The capsule therefore contains approximately 0.33 milligrams of the aerosol-forming substrate per cubic millimetre of the internal cavity 22.

The capsule 14 comprises a plurality of air outlets 30 each of which is in the form of a hole extending through the capsule outer wall 20 and each having a diameter of about 0.5 millimetres. The plurality of air inlets 30 are spaced apart in a circular formation on the upstream end wall 28 of the capsule 14.

The capsule 14 further comprises a plurality of air outlets 32 each of which is in the form of a hole extending through the capsule outer wall 20 and each having a diameter of about 0.5 millimetres. The plurality of air outlets 32 are spaced apart in a circular formation on the downstream end wall 29 of the capsule 14.

The protrusion of the capsule 14 from the upstream end of the hollow tubular element 12 means that the air inlets 30 are located outside of the hollow tubular element 12.

The air inlets 30 and the air outlets 32 are arranged to be substantially symmetric to each other, at opposite ends of the capsule 14.

The arrangement of the air inlets 30 and the air outlets 32 define a plurality of airflow pathways through the internal cavity 22 of the capsule 14 so that, during heating, ambient air can be drawn through the capsule 14 and in contact with the first particles 24 of solid first aerosol-forming substrate. Aerosol generated from the first particles 24 of solid first aerosol-forming substrate upon heating will be drawn out of the capsule 14 along with the ambient air, through the air outlets 32 and along the hollow tubular element 12 to the downstream end 18 of the aerosol-generating article 10.

Each of the first particles 24 of solid first aerosol-forming substrate contained within the capsule 14 is ellipsoidal in shape with a major axis of 0.8 millimetres. The skilled person will appreciate that other shapes and sizes of first particles 24 may be used. For example, in an alternative embodiment, each of the first particles is substantially spherical in shape with a diameter of 0.8 millimetres. Each of the first particles 24 of aerosol-forming substrate is formed of a gel composition having the following composition:

| Component | % by weight |
|---|---|
| Glycerin | 76.8 |
| Alginate | 3.8 |
| Nicotine | 2.4 |
| Levulinic acid | 2.1 |
| Water | 14.4 |
| Calcium chloride | 0.5 |

FIG. 3 shows an aerosol-generating system 100 according to an embodiment of the present invention. The aerosol-generating system 100 comprises an aerosol-generating article 10 as described above. The aerosol-generating system 100 further comprises an aerosol-generating device 102. The aerosol-generating device 102 comprises a device housing 145. The device housing 145 defines a device cavity 142 for receiving the upstream end of the aerosol-generating article 10. The device cavity 142 has an inner diameter which substantially corresponds to the outer diameter of the aerosol-generating article 10. The aerosol-generating device 102 further comprises an inductive heating arrangement 141 comprising an inductor surrounding a portion of the device cavity 142. When the aerosol-generating article 10 is received within the device cavity 142, the capsule 14 is positioned within the inductor coil. During use, a controller (not shown) supplies an alternating electric current from a power supply (not shown) to the inductor coil so that the inductor coil generates a varying magnetic field. The varying magnetic field inductively heats the susceptor material of the second particles 25, which in turn heats the first particles 24 to generate an aerosol from the solid aerosol-forming substrate. The device housing 145 defines a plurality of device air inlets 150 in communication with the device cavity 142. Therefore, the aerosol-generating system 100 comprises an airflow path extending from the device air inlets 150, through the capsule 14 via the capsule air inlets 30 and the capsule air outlets 32, and through the hollow tubular element 12 and the downstream filter segment 50 for delivery of the aerosol to a user.

FIGS. 4 and 5 illustrate an alternative form for the second particles of the capsule 14. In particular, FIGS. 4 and 5 show a second particle 225 comprising a plurality of spaced apart discs 227, each disc 227 formed of a susceptor material comprising stainless steel. The discs 227 are connected to each other by a central column 229, which is preferably also formed of a susceptor material such as stainless steel. The stack of spaced apart discs 227 significantly increases the surface area of the second particle 225 compared to a spherical particle of the same size. The increased surface area increases the rate of emission of heat from the second particles 225, which provide more efficient heating of the first particles 24.

FIGS. 6 and 7 illustrate a further alternative form for the second particles of the capsule 14. In particular, FIGS. 6 and 7 show a second particle 325 having a stellated polyhedral shape formed of a susceptor material comprising stainless steel. As shown in FIG. 7, which illustrates the second particle 325 together with a plurality of first particles 24 each having a spherical shape, the stellated polyhedral shape of the second particle 325 facilitates nesting of the second particle 325 in between the plurality of first particles 24. The increased nesting facilitates mixing of the second particles 325 with the first particles 24 in the capsule 14 and facilitates the transfer of heat from the second particles 325 to the first particles 24.

FIG. 8 shows a cross-sectional view of an alternative capsule 414 for use in the aerosol-generating article 10 of FIG. 1. The capsule 414 of FIG. 8 is similar to the capsule 14 of FIG. 2 and like reference numerals designate like parts. Instead of a plurality of second particles 25, the capsule 414 comprises a single susceptor element 425 formed of a susceptor material comprising stainless steel. The single susceptor element 425 is rod-shaped and extends along almost the entire length of the internal cavity 22 of the capsule 414. The single susceptor element 425 is surrounded by the plurality of first particles 24 so that, during use, heat is transferred from the single susceptor element 425 to the first particles 24.

1.-8. (canceled)

9. An aerosol-generating article for generating an inhalable aerosol upon heating, the aerosol-generating article comprising a capsule, the capsule comprising:
a capsule outer wall defining an internal cavity;
a plurality of first particles within the internal cavity, each of the first particles comprising an aerosol-forming substrate; and
a plurality of second particles within the internal cavity, each of the second particles comprising a susceptor material and no aerosol-forming substrate;
wherein the capsule further comprises at least one of the following:
each of the first particles having a first cross-sectional dimension and each of the second particles having a second cross-sectional dimension, wherein the first cross-sectional dimension and the second cross-sectional dimension are the same, wherein each of the first particles has a spherical shape, wherein each of the second particles has a spherical shape, wherein the first cross-sectional dimension is a diameter of each of the first particles, and wherein the second cross-sectional dimension is a diameter of each of the second particles,
each of the first particles having a first mass and each of the second particles having a second mass, wherein the first mass and the second mass are the same,
each of the first particles having a first density and each of the second particles having a second density, wherein the first density and the second density are the same,
a ratio of a total number of first particles to a total number of second particles being between 0.2 to 1 and 5 to 1, or
a ratio of a total mass of first particles to a total mass of second particles being between 0.2 to 1 and 5 to 1.

10. The aerosol-generating article according to claim 9, wherein the plurality of second particles is mixed with the plurality of first particles.

11. The aerosol-generating article according to claim 9,
wherein each of the first particles has an outer surface comprising a first shape,
wherein each of the second particles has an outer surface comprising a second shape, and
wherein part of the second shape is configured to engage with part of the first shape.

12. The aerosol-generating article according to claim 11, wherein part of the first shape is configured to receive part of the second shape.

13. The aerosol-generating article according to claim 11, wherein part of the second shape is configured to receive part of the first shape.

14. The aerosol-generating article according to claim 9, wherein each of the first particles does not comprise a susceptor material.

15. An aerosol-generating system, comprising:
an aerosol-generating article according to claim 9; and
an aerosol-generating device comprising:
a device cavity configured to receive at least a portion of the aerosol-generating article, and
an inductive heating arrangement configured to inductively heat the plurality of second particles or the single susceptor element.

16. A method of forming a capsule for an aerosol-generating article for generating an inhalable aerosol upon heating, the method comprising:
providing a plurality of first particles each comprising an aerosol-forming substrate;
providing a plurality of second particles each comprising a susceptor material and no aerosol-forming substrate;
mixing the plurality of first particles with the plurality of second particles to form a particle mixture;
providing a capsule outer wall defining an internal cavity; and
inserting the particle mixture into the internal cavity to form a capsule comprising the capsule outer wall and the particle mixture within the internal cavity, the capsule further comprising at least one of the following:
each of the first particles having a first cross-sectional dimension and each of the second particles having a second cross-sectional dimension, wherein the first cross-sectional dimension and the second cross-sectional dimension are the same, wherein each of the first particles has a spherical shape, wherein each of the second particles has a spherical shape, wherein the first cross-sectional dimension is a diameter of each of the first particles and wherein the second cross-sectional dimension is a diameter of each of the second particles,
each of the first particles having a first mass and each of the second particles having a second mass, wherein the first mass and the second mass are the same,
each of the first particles having a first density and each of the second particles having a second density, wherein the first density and the second density are the same,
a ratio of a total number of first particles to a total number of second particles being between 0.2 to 1 and 5 to 1, or
a ratio of a total mass of first particles to a total mass of second particles being between 0.2 to 1 and 5 to 1.
